(19) United States
(12) Patent Application Publication
(10) Pub. No.: US 2025/0208856 A1
(43) Pub. Date: Jun. 26, 2025

(54) Updating of Automation Devices

(71) Applicant: OliverIQ, Sandy, UT (US)

(72) Inventors: Eric Smith, Draper, UT (US); Jory Dunn, West Jordan, UT (US)

(21) Appl. No.: 18/991,237

(22) Filed: Dec. 20, 2024

Related U.S. Application Data
(60) Provisional application No. 63/613,026, filed on Dec. 20, 2023.

(51) Int. Cl. G06F 8/65; G06F 8/71; G06F 11/3668

(52) U.S. Cl. CPC G06F 8/65; G06F 8/71; G06F 11/3688

(57) ABSTRACT

A technology is provided for a method for updating automation devices. The method may include comparing a software version on an automation device to a latest version of software for the automation device as recorded in a version data store to determine whether the software version has been recorded in the version data store. Another operation may be testing the software version against an automation driver in an automation hub when the software version has not been recorded in the version data store. The automation driver on the automation hub may be updated when the test does not pass.

### PRIORITY CLAIM

The application claims priority to U.S. Provisional Patent Application No. 63/613,026 entitled “Updating of Automation Devices”, filed on Dec. 20, 2023, which is hereby incorporated by reference for all the provisional application teaches and describes.

### BACKGROUND

The wide availability of automation devices (e.g., automated lights, light switches, motion detectors, garage door controllers, etc.), video cameras, large screen TVs, wireless audio equipment, IoT (internet of things) devices, and similar electronic equipment has continued to increase interest in having and maintaining an automation network for home, business or public locations. Over time it has become less expensive and easier to buy many networkable electronic components that can be used to control lighting, garage doors, monitor appliances, stream video or music, and automate a variety of other electronic components using an automation network.

Many automation devices, security systems and other electronic devices can be networked into a central controller or automation hub through a wired or wireless network. Examples of electronic components that an individual may desire to interface with a controller and an automation network can include: television screens, wireless audio equipment, video cameras, microphones, audio-visual and entertainment equipment, Alexa devices, Google devices, etc. Other types of devices that can be in communication with the controller can include automation equipment such as: door locks, lighting control switches, fireplace relays, dimmers, thermostats, HVAC, timers, garage door controllers, alarm systems, security sensor and other types of automation equipment. In addition, other home or business equipment can be connected to a central controller or automation hub of automation network such as: USB devices, Fire Wire devices, serial and parallel communication devices, fiber optic connections, a computer network using an Ethernet or wireless connection, and Internet connections. These electronic components that have been described can be used many settings, including home, business, education, government, hotels, churches, and entertainment facilities.

### BRIEF DESCRIPTION OF THE DRAWINGS

FIG. 1 is a block diagram illustrating an example of a system to update automation drivers interfacing with the automation devices that are connected to an automation hub

FIG. 2 is a flowchart illustrating a method for updating automation devices.

FIG. 3 is a flowchart illustrating a method for updating automation devices using version data already in a version data store.

FIG. 4 is a block diagram of a service provider environment according to an example of the present technology.

FIG. 5 is a block diagram that provides an example illustration of a computing device that may be employed in the present technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

This technology describes processes and systems to detect new firmware or software on automation devices or IoT devices. Then the technology may detect the firmware or software changes, update automation drivers, compare firmware and software versions, and deploy updated automation drivers to the automation hubs (or automation devices) using a centralized automation driver distribution system.

One of the current challenges in automation (e.g., in homes, business or institutions) is that each automation device is internet connected and the automation devices may fetch a software update: whenever the automation devices have been programmed to check for updates, when updates are pushed down from a hardware manufacturer, or when the user asks the automation devices to check for software update. In many cases, the manufacturer has control of updating the software and app(s) that controls the automation device. Basically, automation devices may have their software or firmware updated at any time.

In some software or firmware updates, the product manufacturer may change the application programming interface (APIs) or other interfaces to the product. Changes to the APIs may make it difficult for a third party application to continue interacting with the automation device without problems. The developers of such third party applications would like their app to work with any software or API changes for the automation devices that are attached to an automation network.

When a manufacturer of an automation device releases a new app to interface with the automation device, the existing app can look at the current version of software and contact the manufacturer's servers and tell the user that a new version of the app is needed. The app can also look at the version of software or firmware running on the automation device (e.g., a television) and the app can connect to the automation device (e.g., the television). Furthermore, the app knows whether the app should use the old or new APIs the manufacturer has created because the manufacturer has full knowledge of all the changes. However, sometimes manufacturers neglect to tell third parties of such changes or manufacturers may just decide to not publish the changes.

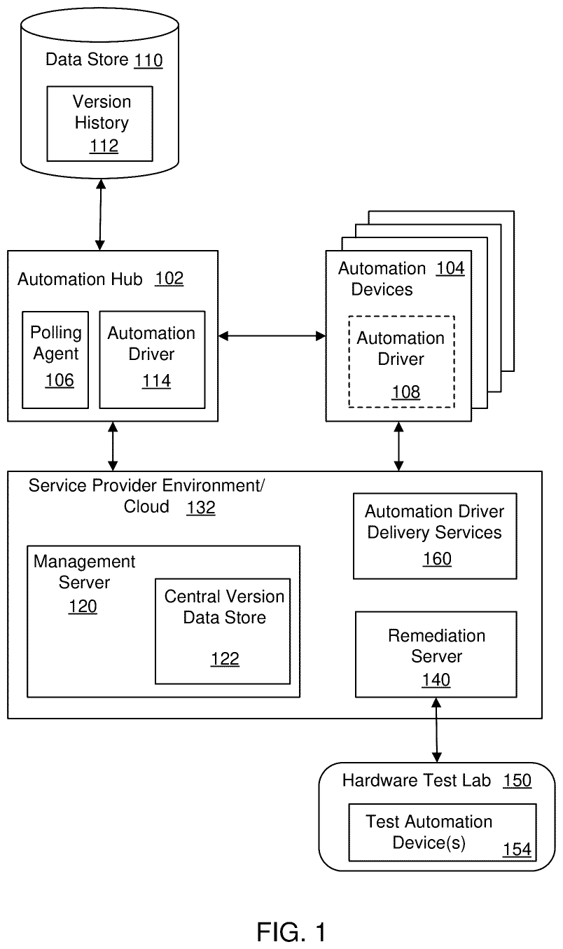

The present technology may include a system and process to update automation drivers interfacing with the automation devices that are connected to an automation hub, as illustrated in FIG. 1. This process may also update the firmware or software on the automation hubs or automated devices, if desired.

FIG. 1 is a block diagram illustrating that an automation hub 102 can perform a round-robin polling of a plurality of automation devices 104 to make sure the automation devices 104 are still connected and online. For example, the automation hub 102 may round robin poll at least one automation device 104 connected to the automation hub 102 when the automation hub 102 is not busy. This polling may occur periodically, such as polling one automation device each second, each minute, five minutes, hour, each day, etc. If the automation devices 104 support the ability to be queried about a current hardware version, firmware version, or software version, then the automation hub 102 can query the automation devices 104 regarding what hardware version, what firmware version and what software versions the automation devices 104 are currently running. The polling may be executed using a polling agent 106 that initiates the polling from the automation hub 102.

Alternatively, automation device information about a current hardware version, firmware version, or software version may be periodically pushed into a version history data store 112 or even a central version data store 122. The automation device information may be pushed by the automation device, a server in a cloud that is synchronized with the automation device(s) 104 or another device with the automation device information.

An automation driver 114 may be defined as a piece of software that is configured to allow the automation hub 102 and automation devices 104 to communicate with each other. For example, the automation hub 102 may communicate data, instructions, state information or other information to the automation devices 104. Similarly, the automation hub 102 may receive data, instructions, state or other information back from the automation devices 104 using the automation drivers 114. The automation drivers 114 may be compared to device drivers that allow an operating system to communicate with peripherals in a computer system, but the automation drivers 114 communicate with automation devices 104 over a local computer network or the internet. In one configuration, a portion of the automation driver 108 may reside on the automation devices 104 as illustrated by the box with the dotted lines or the automation driver may reside completely on the automation devices 104.

The hardware version, firmware version or software version 112 (e.g., version number or version label) being used for the automation device 104 can then be stored in a version history 112 of a data store 110 that is accessible to or associated with the automation hub 102. For example, the data store 102 may be located locally on the local area network (LAN) or in the automation hub itself. A determination can be made regarding whether the automation hub 102 has ever encountered the versions of the hardware, firmware or software on the automation device 104 before. If the automation hub 102 has encountered this version in the past or it is an older version as compared to the most current version of the firmware or software encountered by the automation hub for this automated device, then no action will be taken. However, if the automation hub 102 has not encountered this version of the firmware or software before, then a message may be sent to a management server 120 in the cloud. The management server 120 may be in a private service provider environment or a publication service provider environment (e.g., public or private cloud).

The management server 120 in the cloud 132 may then check to see if any automation hub 102 that can communicate with the management server 120 (e.g., in the entire world or in an entire country) has ever seen this version of the hardware and/or firmware. If this version has been received already from any automation hub 102, then no action will be taken. On the other hand, if this version of the hardware or firmware has never been seen before (as recorded into a central version data store 122) then a notification is sent to a remediation server 140 in order to identify this new version of hardware or firmware and the automation device associated with the new version. The remediation server 140 may be in a cloud 132 or a network operation center (NOC) (not shown). For example, the new version message sent to the remediation server 140 may state that there is a new version of firmware on LG TVs, NEST thermostats or RING doorbells.

A hardware test lab 150 may be available where many automation devices reside for testing and development. The remediation server 140 may receive the new version message and send a message to the matching test automation device 154 in the hardware test lab 150 to force an update on that device in the lab, so the test automation device 154 updates to the new version of the firmware.

In an alternative configuration, the technicians and developers may view the new version message and may go into a hardware test lab where the large number of automation devices are located. The administrator may then force an update on that device by hand.

In the automated case, the remediation server 140 may launch a regression test on the automation drivers of the automation device 154 to make sure that nothing in the firmware or software on the automation device has changed or that a desired functionality for the automation driver still exists. As long as nothing has changed in the firmware and/or API's (application programming interface), then the automation device 154 is marked as “good” or conforming in the central version data store. As a result, the system can determine that the automation drivers for the current version of the hardware and firmware are working properly.

The testing may take place using other types of software testing that are useful to test the automation servers in light of firmware or software changes on the automation device 102. For example, artificial intelligence tests, machine learning tests, dynamic testing, functional testing, exploratory testing or heuristic tests may applied (e.g., by a machine applied process) to the automation drivers 114 against the new firmware on the automation device.

On the other hand, if a problem or change is revealed using the regression test, the technicians or developers in the test lab can try to figure out what the problem is, in order to fix the problem. For example, the technicians or developers may find documentation, call the vendor, use software instrumentation, use debugging tools, or take other steps to see what has changed in the firmware.

The system may also use artificial intelligence (AI) tools or machine learning to analyze the differences between the new firmware or software on the automation device and the automation driver. For example, generative deep neural networks may be used. Then the Al may generate revised source code and/or executable code for the automation driver 114 based on the detected differences. The AI generated code may be tested and if the updated automation driver works correctly or has the desired functionality, then updated automation driver may be sent to automation hubs for use (or automation devices).

Once a change is identified in the firmware, the technicians, developers or automated AI code generation may build an updated automation driver 114. This updated automation driver 114 may be loaded into automation driver delivery services 160 that are accessible to automation hubs 102 and similar devices. The developers can mark the updated automation driver to indicate that automation devices (e.g., the automation hub 102) with an old version of the automation driver need to update the automation driver 114. Accordingly, some automation devices 104 may be identified as receiving an update to the device firmware and then the automation hub 102 may contact the automation driver delivery services 160 in the cloud to see if the automation hub 102 needs to download an updated automation driver 114.

Providing automated updates to automation drivers used by an automation hub 102 or controller avoids call from consumers about automation device problems 104 that might otherwise be solved with an automation driver 108 update. For example, an automation dealer may frequently be called into a location where an automation system has been installed because an automation device 104 has received a new software or firmware version but the new firmware or software has failed to integrate with automation system (e.g., automation hub 102). However, what may be needed is a software update of the automation drivers 114 for the automation hub 102 to communicate with the automation devices.

This technology provides an on-site solution, where the automation hub 102 may talk to the automation devices 104 connected to the automation hub 102 to determine a version of software, firmware or hardware for an automation device 104. The system may then compare the firmware versions of identified automation devices 104 to the most current versions of the firmware or software seen by any automation hub 102 in the automation network to determine if there are problems with the automation driver 114 which provides communication between the automation hub 102 and the automation devices 104. Finally, the automation hub 102 may fetch updates from a central repository using the automation driver delivery services 160 when a versioning issue has been identified.

Alternatively, a technician may login to an automation system with a problem and load a new automation driver 114 onto the automation hub 102 to allow the automation hub 102 to communicate with the automation devices 104 in a seamless process. In either the automated update case or the human update case, an incompatibility may be automatically detected between the automation hub's drivers 114 and the current hardware, firmware or software versions on the automation device 104. When a version conflict is detected, then a fix may deployed immediately.

The automation hub 102 or central controller may be installed in a location. The automation hub 102 may monitor the automation devices 104 connected to the automation hub 102. Once there is a recognition of new hardware, firmware or software, then the system can determine whether the automation hub 102 needs an update to the automation drivers 114 or not. This determination may be performed by checking the central version data store 122 that is being automatically updated over time. In the past, automation device owners have had to manage their own automation devices. This may result in automation devices 104 that are not working because the hardware, firmware or software on the automation device 104 has changed but the owners of the automation system are not aware of the changes. However, this technology, can monitor any companies' automation devices regardless of the automation device type.

When there are problems with an automation driver 114, the problem can be sent to a test lab to do a test on the problem, bug or conflict. When the technicians or developers figure out what the problem is with the automation driver 114, then the updated automation drivers that fix the problem can be posted to the automation driver delivery service 160 or a service accessible to the automation hubs 102.

For example, suppose an automation hub 102 has a new automation driver 114 for a garage door opener but the automation system's configuration or layout has four (4) such automation devices. In this case, the automation hub 102 may update the automation driver 114 for each garage door opener with the same automation driver 114. In another case, the automation system may have 2 LG televisions that are connected to the automation hub (in this case with different firmware and hardware), and if one has received a firmware update and the other one did not, then the automation hub 102 can update the automation driver 114 for the first television and leave the second television alone. This way the automation driver 114 is only updated for the automation device that has actually updated its firmware or software. Later, when the second device updates, then the automation hub may download and update the automation driver 108 for that the second automation device at that point.

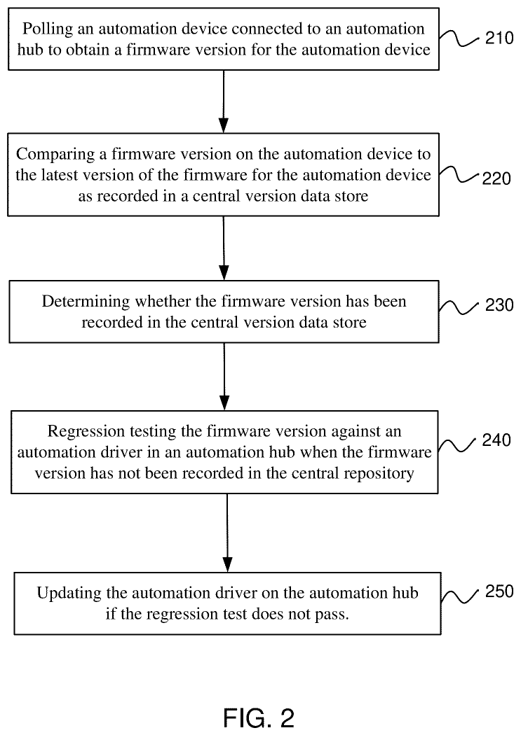

FIG. 2 is a flowchart illustrating a method for updating automation devices. The method may include polling an automation device connected to an automation hub to obtain a firmware version for the automation device, as in block 210. The polling of the automation devices may also obtain: a hardware version for the automation devices, a firmware version for the automation devices, or a software version for the devices. The automation devices may be polled using a polling agent on the automation hub.

The hardware versions and firmware versions for the automation devices that are in communication with the automation hub may be stored in a location that is accessible to the automation hub (e.g., a local data store or an accessible data store in the cloud). A firmware version on the automation device may be compared to the latest version of the firmware for the automation device as recorded in a central version data store, as in block 220.

A determination may be made as to whether the firmware version has been recorded in the central version data store, as in block 230. The central version data store may be managed by a management service in a cloud computing environment. The firmware version on the automation device may be updated when the automation device does not have the latest firmware version.

For example, a new version message may be received at a remediation server. Then the remediation server may send a message from the remediation server to a test automation device in a hardware test lab to update that test automation device in the hardware test lab for testing. The firmware version may be regression tested against an automation driver in an automation hub when the firmware version has not been recorded in the central repository, as in block 240.

The automation driver on the automation hub may be updated if the regression test does not pass, as in block 250. Updated automation drivers may be provided using automation driver delivery services that are accessible to automation hubs or automation devices. In some situations, a portion of an automation driver may reside on an automation device and may be updated.

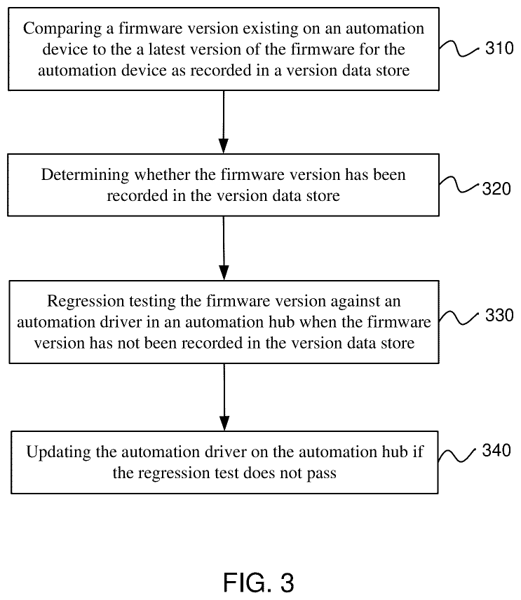

FIG. 3 is flowchart illustrating a method for updating automation devices using firmware versions already in a version data store. The method may include comparing a firmware version existing on an automation device to a latest version of the firmware for the automation device as recorded in a version data store, as in block 310. The version of the firmware or software for the automation device may have been placed in the version data store by the automation device, the automation hub, a server or service that is in communication with the automation device. In other examples, the automation device may be polled (as described earlier) for the version of the firmware or software or the automation devices may periodically push the version of the firmware or software to the version data store. The version data store may be a localized version history or central version data store. The version data store may store a hardware version, a firmware version or software version for the automation devices.

Another operation can be determining whether the firmware version has been recorded in the version data store, as in block 320. If the firmware version has not been recorded, a new version message may be sent to a remediation server. The remediation server can then send a message to a test automation device in a hardware test lab to update that test automation device in the hardware test lab for testing. Regression testing the firmware version against an automation driver in an automation hub may be performed when the firmware version has not been recorded in the version data store, as in block 330.

The automation driver on the automation hub may be updated if the regression test does not pass, as in block 340. Updated automation drivers may be provided using automation driver delivery services that are accessible to automation hubs or automation devices. In addition, the firmware version on the automation device may be updated when the automation device does not have the latest firmware version.

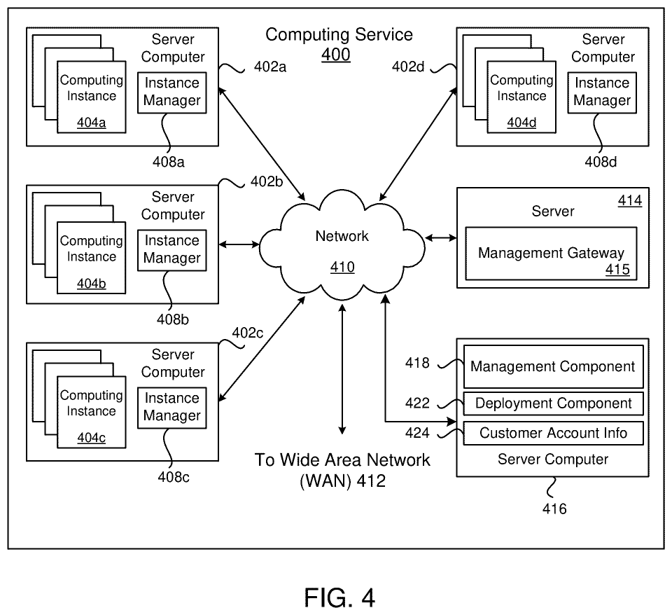

FIG. 4 is a block diagram illustrating an example computing service 400 that may be used to execute and manage a number of computing instances 404a-d upon which the present technology may execute. In particular, the computing service 400 depicted illustrates one environment in which the technology described herein may be used. The computing service 400 may be one type of environment that includes various virtualized service resources that may be used, for instance, to host computing instances 404a-d.

The computing service 400 may be capable of delivery of computing, storage and networking capacity as a software service to a community of end recipients. In one example, the computing service 400 may be established for an organization by or on behalf of the organization. That is, the computing service 400 may offer a “private cloud environment.” In another example, the computing service 400 may support a multi-tenant environment, wherein a plurality of customers may operate independently (i.e., a public cloud environment). Generally speaking, the computing service 400 may provide the following models: Infrastructure as a Service (“IaaS”) and/or Software as a Service (“SaaS”). Other models may be provided. For the IaaS model, the computing service 400 may offer computers as physical or virtual machines and other resources. The virtual machines may be run as guests by a hypervisor, as described further below. The PaaS model delivers a computing system that may include an operating system, programming language execution environment, database, and web server.

Application developers may develop and run their software solutions on the computing service system without incurring the cost of buying and managing the underlying hardware and software. The SaaS model allows installation and operation of application software in the computing service 400. End customers may access the computing service 400 using networked client devices, such as desktop computers, laptops, tablets, smartphones, etc. running web browsers or other lightweight client applications, for example. Those familiar with the art will recognize that the computing service 400 may be described as a “cloud” environment.

The particularly illustrated computing service 400 may include a plurality of server computers 402a-d. The server computers 402a-d may also be known as physical hosts. While four server computers are shown, any number may be used, and large data centers may include thousands of server computers. The computing service 400 may provide computing resources for executing computing instances 404a-d. Computing instances 404a-d may, for example, be virtual machines. A virtual machine may be an instance of a software implementation of a machine (i.e. a computer) that executes applications like a physical machine. In the example of a virtual machine, each of the server computers 402a-d may be configured to execute an instance manager 408a-d capable of executing the instances. The instance manager 408a-d may be a hypervisor, virtual machine manager (VMM), or another type of program configured to enable the execution of multiple computing instances 404a-d on a single server. Additionally, each of the computing instances 404a-d may be configured to execute one or more applications.

A server 414 may be reserved to execute software components for implementing the present technology or managing the operation of the computing service 400 and the computing instances 404a-d. For example, the server 414 may include a management gateway 415 or client gateway with the functions described earlier. A computing instance 404a-d may also be used as a server for managing the automation network, as described in FIG. 1.

A server computer 416 may execute a management component 418. A customer may access the management component 418 to configure various aspects of the operation of the computing instances 404a-d purchased by a customer. For example, the customer may setup computing instances 404a-d and make changes to the configuration of the computing instances 404a-d.

A deployment component 422 may be used to assist customers in the deployment of computing instances 404a-d. The deployment component 422 may have access to account information associated with the computing instances 404a-d, such as the name of an owner of the account, credit card information, country of the owner, etc. The deployment component 422 may receive a configuration from a customer that includes data describing how computing instances 404a-d may be configured. For example, the configuration may include an operating system, provide one or more applications to be installed in computing instances 404a-d, provide scripts and/or other types of code to be executed for configuring computing instances 404a-d, provide cache logic specifying how an application cache is to be prepared, and other types of information. The deployment component 422 may utilize the customer-provided configuration and cache logic to configure, prime, and launch computing instances 404a-d. The configuration, cache logic, and other information may be specified by a customer accessing the management component 418 or by providing this information directly to the deployment component 422.

Customer account information 424 may include any desired information associated with a customer of the multi-tenant environment. For example, the customer account information may include a unique identifier for a customer, a customer address, billing information, licensing information, customization parameters for launching instances, scheduling information, etc. As described above, the customer account information 424 may also include security information used in encryption of asynchronous responses to API requests. By “asynchronous” it is meant that the API response may be made at any time after the initial request and with a different network connection.

A network 410 may be utilized to interconnect the computing service 400 and the server computers 402a-d, 416. The network 410 may be a local area network (LAN) and may be connected to a Wide Area Network (WAN) 412 or the Internet, so that end customers may access the computing service 400. In addition, the network 410 may include a virtual network overlaid on the physical network to provide communications between the servers 402a-d. The network topology illustrated in FIG. 4 has been simplified, as many more networks and networking devices may be utilized to interconnect the various computing systems disclosed herein.

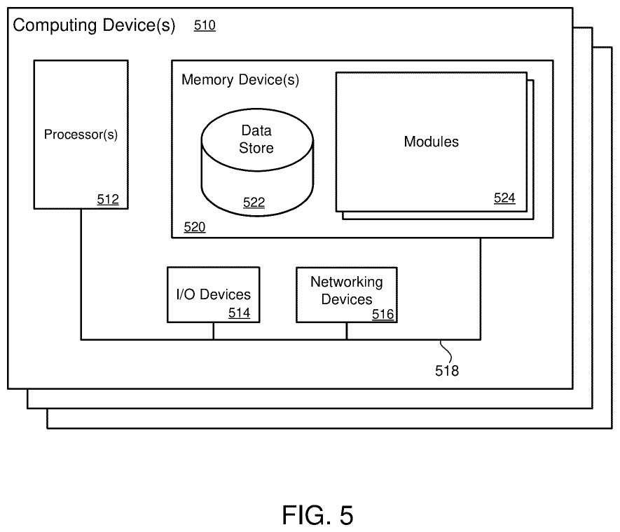

FIG. 5 illustrates a computing device 510 on which modules of this technology may execute. The computing device 510 is illustrated on which a high level example of the technology may be executed. The computing device 510 may include one or more processors 512 that are in communication with memory devices 520. The computing device may include a local communication interface 518 for the components in the computing device. For example, the local communication interface may be a local data bus and/or any related address or control busses as may be desired.

The memory device 520 may contain modules 524 that are executable by the processor(s) 512 and data for the modules 524. The modules 524 may execute the functions described earlier. A data store 522 may also be located in the memory device 520 for storing data related to the modules 524 and other applications along with an operating system that is executable by the processor(s) 512.

Other applications may also be stored in the memory device 520 and may be executable by the processor(s) 512. Components or modules discussed in this description that may be implemented in the form of software using high programming level languages that are compiled, interpreted or executed using a hybrid of the methods.

The computing device may also have access to I/O (input/output) devices 514 that are usable by the computing devices. An example of an I/O device is a display screen that is available to display output from the computing devices. Other known I/O device may be used with the computing device as desired. Networking devices 516 and similar communication devices may be included in the computing device. The networking devices 516 may be wired or wireless networking devices that connect to the internet, a LAN, WAN, or other computing network.

The components or modules that are shown as being stored in the memory device 520 may be executed by the processor 512. The term “executable” may mean a program file that is in a form that may be executed by a processor 512. For example, a program in a higher level language may be compiled into machine code in a format that may be loaded into a random access portion of the memory device 520 and executed by the processor 512, or source code may be loaded by another executable program and interpreted to generate instructions in a random access portion of the memory to be executed by a processor. The executable program may be stored in any portion or component of the memory device 520. For example, the memory device 520 may be random access memory (RAM), read only memory (ROM), flash memory, a solid state drive, memory card, a hard drive, optical disk, floppy disk, magnetic tape, or any other memory components.

The processor 512 may represent multiple processors and the memory 520 may represent multiple memory units that operate in parallel to the processing circuits. This may provide parallel processing channels for the processes and data in the system. The local interface 518 may be used as a network to facilitate communication between any of the multiple processors and multiple memories. The local interface 518 may use additional systems designed for coordinating communication such as load balancing, bulk data transfer, and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for updating automation devices, comprising:
polling an automation device connected to an automation hub to obtain a firmware version for the automation device;
comparing a firmware version on the automation device to the latest version of the firmware for the automation device as recorded in a central version data store;
determining whether the firmware version has been recorded in the central version data store;
testing the firmware version against an automation driver in an automation hub when the firmware version has not been recorded in the central version data store; and
updating the automation driver on the automation hub if the test does not pass.

2. The method as in claim 1, further comprising updating the firmware version on the automation device when the automation device does not have a latest firmware version.

3. The method as in claim 1, further comprising polling the automation device to obtain at least one of: a hardware version for the automation devices, a firmware version for the automation devices, or a software version for the automation devices.

4. The method as in claim 1, further comprising:
receiving a new version message at a remediation server; and
sending a message from the remediation server to a test automation device in a hardware test lab to update that test automation device in the hardware test lab for testing.

5. The method as in claim 1, further comprising providing updated automation drivers using automation driver delivery services that are accessible to automation hubs or automation devices.

6. The method as in claim 1, further comprising polling the automation devices using a polling agent on the automation hub.

7. The method as in claim 1, further comprising wherein the central version data store is managed by a management service in a cloud computing environment.

8. The method as in claim 1, further comprising storing a hardware version and firmware version for the automation devices that is accessible to the automation hub.

9. The method as in claim 1, wherein at least a portion of an automation driver resides on an automation device and is updated.

10. A method for updating automation devices, comprising:
comparing a firmware version existing on an automation device to a latest version of firmware for the automation device as recorded in a version data store;
determining whether the firmware version has been recorded in the version data store;
regression testing the firmware version against an automation driver in an automation hub when the firmware version has not been recorded in the version data store to determine whether the automation driver provides a desired functionality; and
updating the automation driver on the automation hub if a regression test does not pass.

11. The method as in claim 10, further comprising polling the automation device connected to the automation hub to obtain a firmware version for the automation device.

12. The method as in claim 11, further comprising polling the automation device using a polling agent on the automation hub.

13. The method as in claim 11, further comprising polling the automation device to obtain at least one of: a hardware version for the automation device, a firmware version for the automation device, or a software version for the automation devices.

14. The method as in claim 10, further comprising updating the firmware version on the automation device when the automation device does not have a latest firmware version.

15. The method as in claim 10, further comprising:
receiving a new version message at a remediation server; and
sending a message from the remediation server to a test automation device in a hardware test lab to update that test automation device in the hardware test lab for testing.

16. The method as in claim 10, further comprising providing updated the automation driver using automation driver delivery services that are accessible to automation hubs or automation devices.

17. The method as in claim 10, further comprising wherein the central version data store is managed by a management service in a cloud computing environment.

18. The method as in claim 10, further comprising storing a hardware version and firmware version for the automation devices that is accessible to the automation hub.

19. The method as in claim 10, wherein at least a portion of an automation driver resides on the automation device and is updated.

20. A method for updating automation devices, comprising:
comparing a software version on an automation device to a latest version of software for the automation device as recorded in a version data store to determine whether the software version has been recorded in the version data store;
testing the software version against an automation driver in an automation hub when the software version has not been recorded in the version data store; and
updating the automation driver on the automation hub when the test does not pass.

21. The method as in claim 20, further comprising polling the automation device to obtain at least one of: a hardware version for the automation devices, a firmware version for the automation devices, or a software version for the automation devices.
